(19) United States
(12) Patent Application Publication
(10) Pub. No.: US 2008/0121501 A1
(43) Pub. Date: May 29, 2008

(54) Switch structure having integrated damper for lighting glove box lamp

(76) Inventor: Gye Yong Ahn, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/647,476

(22) Filed: Dec. 27, 2006

(30) Foreign Application Priority Data
Nov. 28, 2006 (KR) 10-2006-0118276

(51) Int. Cl. H01H 3/16

(52) U.S. Cl. 200/61.81

(57) ABSTRACT

A switch structure having an integrated damper for lighting a glove box lamp includes a damper cylinder with a hollow space therein assembled to a glove box housing, a piston rod slides in response to opening and closing of the glove box with one end thereof fixed at a predetermined position of a glove box, a terminal fixed to a front end of the damper cylinder, and a switch contact fixed to the piston rod to turn on a lamp by contacting the terminal. The switch contact has a structure for contacting the terminal while the amount of stroke thereof varies by an elasticity varying member along a slot which is formed in a length direction of the piston at a center portion thereof.

### CROSS-REFERENCE TO RELATED APPLICATION

This application claims priority to and the benefit of Korean Patent Application No. 10-2006-0118276 filed in the Korean Intellectual Property Office on Nov. 28, 2006, the entire contents of which are incorporated herein by reference.

### BACKGROUND OF THE INVENTION

(a) Field of the Invention

The present invention relates to a switch structure having an integrated damper for lighting a glove box lamp, and more particularly to a switch structure having an integrated damper for lighting a glove box lamp in which the lamp can be turned on in a state that a glove box is partially opened.

(b) Description of the Related Art

Generally, in front of a driver seat and a passenger seat, an instrument panel is provided to which various meters, an audio system, an air conditioning unit, and various switches are fixed and which separates the engine space and a cabin. An empty space is typically formed at the right side of the instrument panel, and a glove box for receiving small articles is generally provided in this empty space.

The glove box is often comprised of an inner box and an outer lid for covering the inner box. The glove box lid is configured to be opened and closed by with a hinge along one edge. Recently, in order to make the glove box 100 lid operate more smoothly, a damper 200 (referring to FIG. 3) for regulating opening speed of the glove box 100 has been provided.

In addition, a lamp for illuminating an inner space of the glove box 100 when the glove box 100 is opened is frequently provided.

However, when things are excessively contained in the glove box 100, the glove box 100 may be deformed so that the switch for lighting the lamp may malfunction. This may prevent operation of the lamp or, alternately, keep the glove box lamp turned on, which may cause the battery to be charged. In an attempt to address this problem switches have been located on the damper. However, since the conventional switch structure having an integrated damper for lighting a glove box lamp is configured such that the lamp is turned on only when the glove box 100 is completely opened, there is a problem that the lamp is not turned on in a state that the glove box 100 is not completely opened.

### SUMMARY OF THE INVENTION

Embodiments of the present invention provide a switch structure having an integrated damper for lighting a glove box lamp having advantages of being able to light a lamp even when a glove box is partially opened.

An exemplary embodiment of the present invention provides a switch structure having an integrated damper for lighting a glove box lamp including: a damper cylinder which has a hollow space therein and is assembled to a glove box housing in a state; a piston rod which forward and rearward slides in response to opening and closing of the glove box in a state that one end thereof is fixed at a predetermined position of a glove box; a terminal which is fixed to a front end of the damper cylinder; and a switch contact which is fixed to the piston rod and makes a lamp be turned on by contacting the terminal. The switch contact has a structure of contacting the terminal while amount of stroke thereof varies elastically by an elasticity varying member along a slot which is formed in a length direction of the piston at a center portion thereof.

The elasticity varying member may include: a compression spring which is installed inside the slot of the piston rod; and a sliding structure which is fixed to a front end of the compression spring and to a front side of which the switch contact is fixed.

The sliding structure may be positioned in a direction of movement of the piston rod with respect to the compression spring, and the compression spring is positioned at the rear thereof.

### BRIEF DESCRIPTION OF THE DRAWINGS

FIG. 1 is an exploded perspective view of a switch structure having an integrated damper for lighting a glove box lamp according to an exemplary embodiment of the present invention.

FIG. 2A and FIG. 2B are cross-sectional views showing operating states of a switch structure having an integrated damper for lighting a glove box lamp according to an exemplary embodiment of the present invention.

FIG. 3 is a drawing showing an operating state of a conventional damper for a glove box.

### DETAILED DESCRIPTION OF THE EMBODIMENTS

Exemplary embodiments of the present invention will hereinafter be described in detail with reference to the accompanying drawings.

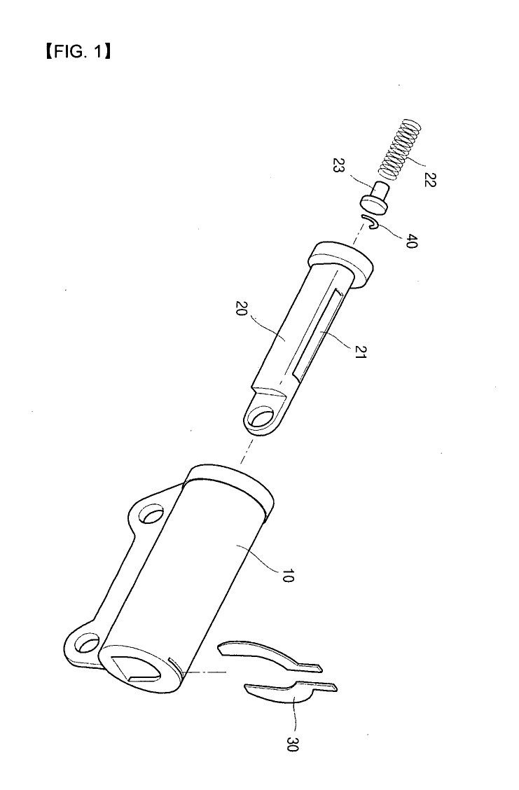

As shown in FIG. 1, a switch structure having an integrated damper for lighting a glove box lamp according to an exemplary embodiment of the present invention is mounted to a damper 200. The damper comprises a damper cylinder 10, having a cylindrical shape with a hollow space therein, assembled to a glove box housing and a piston rod 20 that slides forward and rearward in response to opening and closing of the glove box 100. One end of the piston rod is fixed at a predetermined position to glove box 100.

As part of the switching structure, a terminal 30, which is electrically connected to a lamp, is fixed to an end of the damper cylinder 10. A narrow groove is formed at an inner side of the damper cylinder 10, and a pair of terminals 30 are provided in a circular structure therein and a portion of the terminal 30 is extruded toward the outside so as to be easily electrically connected to the lamp.

A switch contact 40, which is configured to contact the terminal 30 so as to conduct electricity thereby lighting the lamp, has a structure for contacting the terminal 30. The stroke of switch contact 40 is varied by an elasticity varying member along a slot 21, which is formed in a length direction of the piston rod 20 at a center portion thereof.

A compression spring 22 is installed in the slot 21 of the piston rod 20. A sliding structure 23 is fixed to an end of the compression spring 22 and has a projection which is fixed to the switch contact 40 at a front portion thereof in a state that a portion thereof is extruded toward the outside. The sliding structure 23 is positioned in a direction of movement of the piston rod 20 with respect to the compression spring 22, and the compression spring 22 is positioned at the rear thereof.

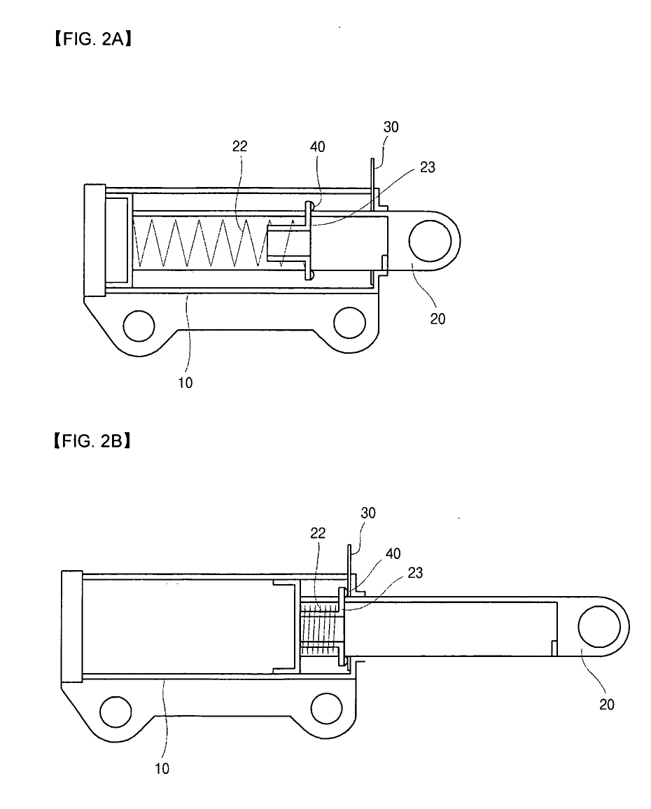

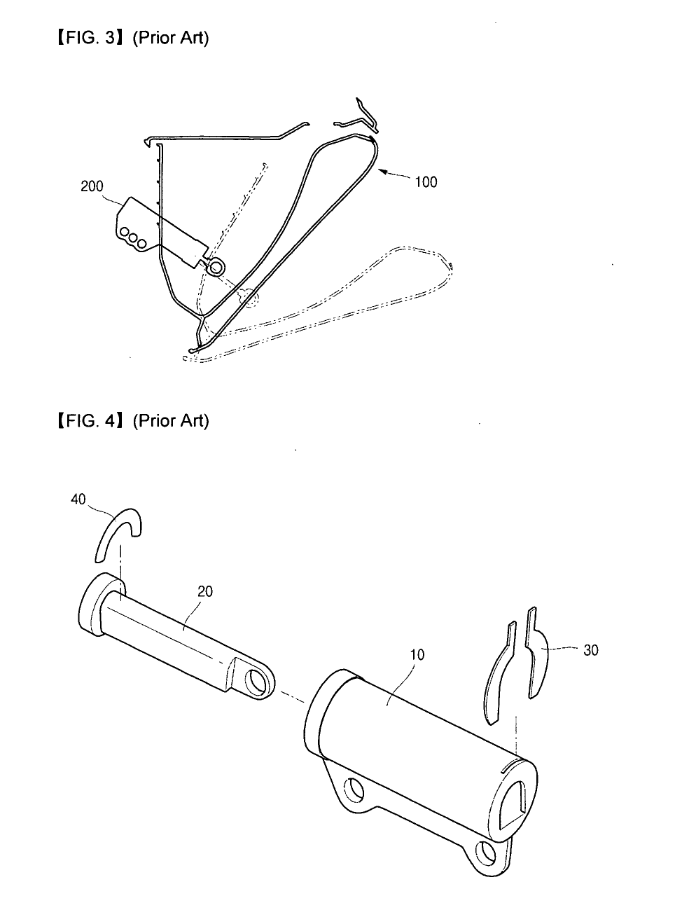

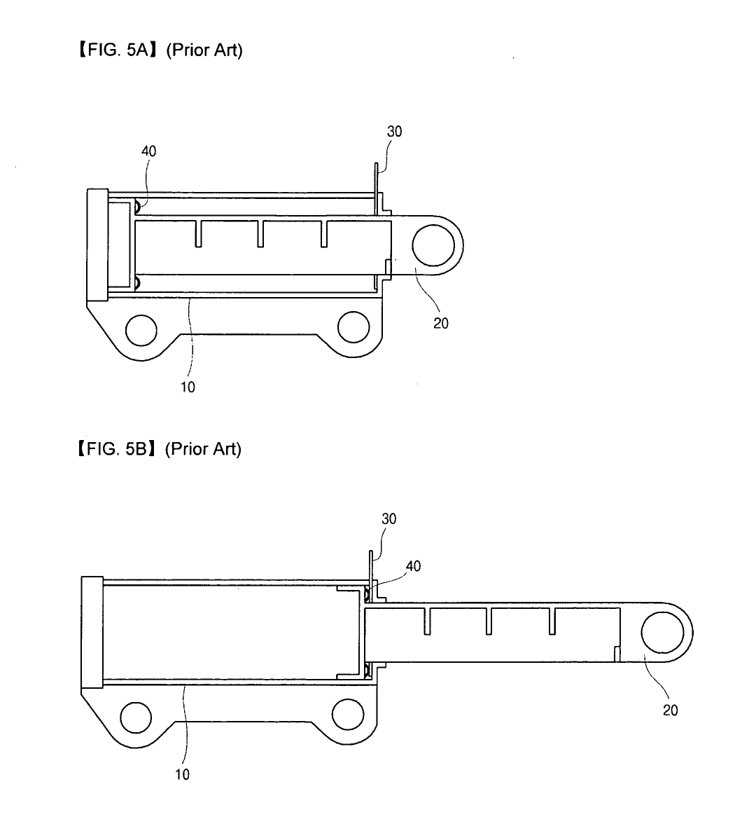

Operation of a switch structure having an integrated damper for lighting a glove box lamp according to an exemplary embodiment of the present invention will be explained hereinafter with reference to FIG. 2A and FIG. 2B.

Firstly, if the glove box 100 is opened, the piston rod 20 which is fixed to the rear surface of the glove box 100 comes out from the damper cylinder 10.

Then, the switch contact 40 which is positioned at the protrusion of the sliding structure 23 which is inserted into the slot 21 of the piston rod 20 and is fixed to a front end of the compression spring 22 contacts the terminal 30, and amount of stroke varies in a state that the switch contact 40 and the terminal 30 contact one another by the compression spring 22.

Accordingly, the lamp is continued to be turned on from a state that the glove box 100 is partially opened so that the lamp is turned on to a state the glove box 100 is completely opened.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to a switch structure having an integrated damper for lighting a glove box lamp according to an exemplary embodiment of the present invention, the lamp can be turned on even in a state that the glove box is partially opened, and since amount of opening of the glove box can be regulated by the value of set amount of stroke of the sliding structure, good quality and functionality can be enhanced.

What is claimed is:

1. A switch structure integrated in a damper, comprising:
a damper cylinder defining a hollow space therein configured and dimensioned to be assembled to a glove box;
a piston rod forwardly and rearwardly sliding in said cylinder in response to opening and closing of the glove box;
a terminal which fixed to a front end of the damper cylinder; and
a switch contact fixed to the piston rod configured to complete an electrical circuit by contacting the terminal,
wherein the switch contact is configured to contact the terminal with varying stroke of the piston by an elasticity varying member carried in a slot formed in a length direction of the piston at a center portion thereof.

2. The switch structure of claim 1, wherein the elasticity varying member comprises:
a compression spring installed inside the slot of the piston rod; and
a sliding structure fixed to a front end of the compression spring and to a front side of which the switch contact is fixed.

3. The switch structure of claim 2, wherein the sliding structure is positioned in a direction of movement of the piston rod with respect to the compression spring, and the compression spring is positioned at the rear thereof.

4. A switch structure integrated in a damper, comprising:
a damper cylinder;
a piston mounted in the damper cylinder with a rod extending therefrom at a forward end of said cylinder;
a switch contact slidably mounted on the piston rod inside the damper cylinder, wherein the said switch contact is configured to contact the switch terminal to form an electrical switch; and
a biasing member acting between the switch contact and piston to bias the switch contact into contact with the switch terminal over a varying range of stroke of the piston.
